(19) United States
(12) Patent Application Publication
(10) Pub. No.: US 2017/0091167 A1
(43) Pub. Date: Mar. 30, 2017

(54) Input Processing

(71) Applicants: Ehtasham Malik, Bothell, WA (US); Christopher J. Wolff, Bellevue, WA (US)

(72) Inventors: Ehtasham Malik, Bothell, WA (US); Christopher J. Wolff, Bellevue, WA (US)

(21) Appl. No.: 14/866,763

(22) Filed: Sep. 25, 2015

(51) Int. Cl. G06F 17/27; G06F 3/0489; G06F 3/0484; G06F 3/0482

(52) U.S. Cl. CPC G06F 17/276; G06F 3/0482; G06F 3/04895; G06F 3/04842

(57) ABSTRACT

Input Processing provides a way of inputting data on any keyboard. A word suggestion menu may suggest words based, at least partially, on the number of times a user presses a key. For example, a user may start typing a word, but rather than spelling it out, the user may simply tap on the same letter repeatedly until the desired word appears. The user may not have to type the correct letters of a desired word to receive a suggestion of the desired word.

### FIELD

This disclosure relates to input processing.

### BACKGROUND

In this digital age, many people want to communicate more efficiently. Keyboard input requires a user to type out or swipe over the different letters of words, for example. Conventional typing is often time-consuming and inefficient.

### SUMMARY

The following presents a simplified summary of the disclosure to provide a basic understanding to the reader. This summary is not an extensive overview of the disclosure, nor does it identify key or critical elements of the claimed subject matter, or define its scope. Its sole purpose is to present some concepts disclosed in a simplified form as a precursor to the more detailed description that is later presented.

The instant application discloses, among other things, input processing. According to one embodiment, input processing may be configured to suggest one or more n-grams based, at least partially, on the number of times the user inputs a character. For example, a user may start typing a desired word, but rather than spelling it out, the user may simply tap on the same letter repeatedly until the desired word appears on a word suggestion menu. The user may not have to type the correct letters of the desired word to receive a suggestion. For example, the user may type “he” and continue typing the “e” key four times instead of once, and Tap Keyboard may suggest “heads,” “heals,” and “hello” as the possible desired words. Words may be presented in order of common usage, in order of usage by a particular user or group of users, in alphabetical order, or in an order set by a configuration setting.

Many of the attendant features may be more readily appreciated as they become better understood by reference to the following detailed description considered in connection with the attached drawings.

### BRIEF DESCRIPTION OF THE DRAWINGS

FIG. 1 is a keyboard on which input processing may be implemented, according to one embodiment.

FIG. 2 is a flow diagram illustrating input processing process, according to one embodiment.

FIG. 3 illustrates a system capable of supporting input processing, according to one embodiment.

FIG. 4 illustrates a component diagram of a computing device, according to one embodiment.

### DETAILED DESCRIPTION

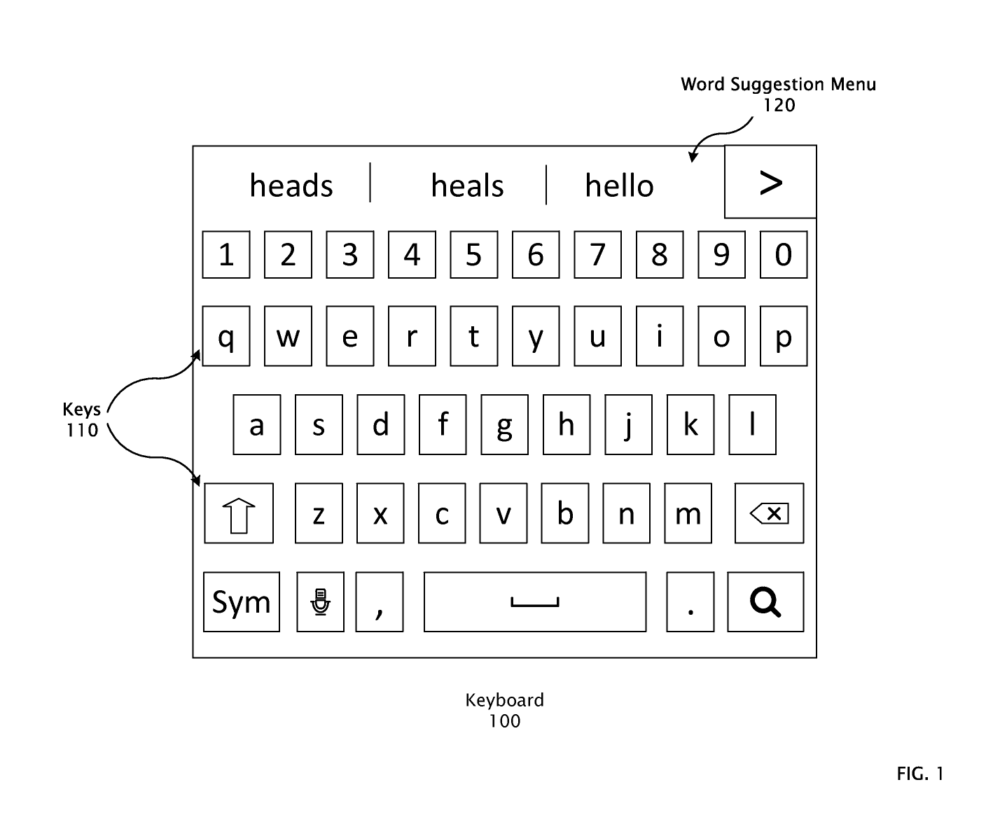

FIG. 1 is a Keyboard 100 on which Input Processing may be implemented, according to one embodiment. Input Processing may provide a way of inputting data on any keyboard. Keyboard 100 may comprise a plurality of Keys 110, which may be any combination of alphabetical keys, numerical keys, punctuation keys, editing keys, navigation keys, and emoji keys, for example. Keyboard 100 may be configured to suggest words based, at least partially, on the number of times a key is pressed. Word suggestions may be displayed on Word Suggestion Menu 120, for example.

According to one embodiment, a user may start typing a word, but rather than spelling it out completely, the user may simply tap on the same letter repeatedly until the desired word appears on Word Suggestion Menu 120. A contiguously repeated letter may be considered a wildcard for pattern matching. In another embodiment, a particular input or combination of inputs may represent wildcard characters. The user may type a few or more letters if the user wasn't sure about the spelling of the desired word or wasn't seeing correct word predictions, for example. The user may not have to type the correct letters of the desired word to receive a suggestion. For example, the user may type “he” and continue typing the “e” key four times instead of once, and Input Processing may suggest “heads,” “heals,” and “hello” as the possible desired words. Words may be presented in order of common usage, in order of usage by a particular user or group of users, in alphabetical order, or in an order set by a configuration setting.

For example, a user may type “thhh”, where the repeated “h” may act as a wildcard. which may represent they, that, then, than, thin, and a number of other words. Suggested words may include they, that, then, than, and a number of other words. To reduce the possibilities, the user may instead type “thhn”, where the “n” will restrict the suggested words to four-letter words starting with “th” and ending in “n”. A user may type any combination of letters in appropriate places and repeated letters as wildcards to provide a pattern for suggested words.

In another embodiment, misspellings or other typographical errors may be accommodated, and words may be suggested for words which may have a different number of letters than the number entered. In yet another embodiment, suggested words may be suggested that are longer than a pattern entered, treating the pattern entered as a beginning of a word, for example.

Input Processing may be configured to function on any keyboard such as a conventional hardware keyboard or touch keyboard for a desktop computer, laptop computer, smartphone, tablet, or wearable devices such as a smartwatch, activity tracker, or intelligent eyewear, for example. A person skilled in the art will also understand that Input Processing may operate with a keyboard designed for any language, geographical location, or physical disability, for example.

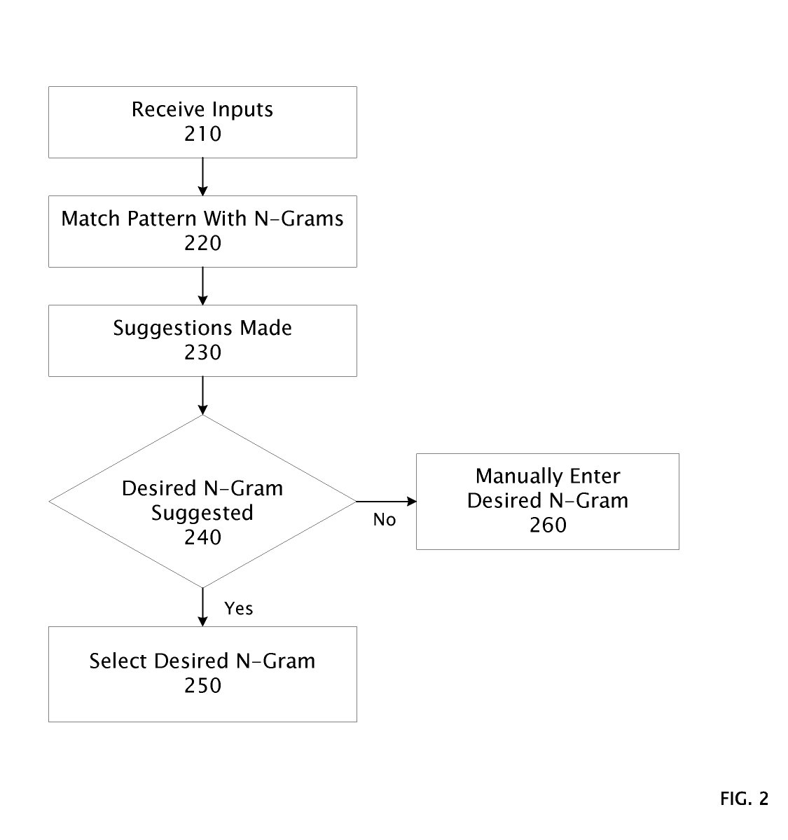

FIG. 2 is flow diagram illustrating an Input Processing process, according to one embodiment. An n-gram is a contiguous sequence of n items from a given sequence of text or speech. The items may be phonemes, syllables, letters, words, or base pairs, according to the application. Words are examples of n-grams.

At Receive Inputs 210, a user may, for example, press one or more keys on Keyboard 100 to begin typing a desired word. Anytime, the user may repeatedly press a key to represent wildcard characters. Match Pattern with N-Grams 220 may compare a pattern received with words found in a dictionary. Suggestions may be Made 230, and one or more matched words may be displayed in a word suggestion menu. The word suggestions may be based, at least partially, on the number of keys the user pressed. For example, the use may begin typing “definitely” by typing “def” and following that by simply pressing the “f” key seven times rather than typing “initely”. This may result in any ten-letter words starting with “def” to be suggested, such as “deficient,” “definitely,” “definitive,” “definitize,” and “definitude.” Determination of the word suggestions may utilize a dictionary or other word source.

One having skill in the art will recognize that different types of pattern matching may be used to support, for example, words starting with particular letters, particular letters at the end of a word, or letters typed in the proper places throughout the word. For example, “ttt,” “thh,” or “the” may each be used to get a desired word “the.” Different words may be suggested for each of these combinations as well; for example “ttt” may also match any three letter word starting with a “t”. Providing additional letters for a pattern may allow better predictions for word suggestions.

In another embodiment, a dedicated input or combination of inputs may be used as a wildcard indicator. For example, on a keyboard a dedicated key may be used to represent a wildcard character. In another embodiment a combination of keys, for example CTRL+spacebar, may be used to represent a wildcard character. Other embodiments may use different ways to indicate repeated symbols to represent wildcard characters. For example, a device containing an accelerometer or other sensor that can measure movement may be shaken to represent repeated characters.

In yet another embodiment, Input Processing may implement error correction. For example, if Input Processing receives a sequence of inputs representing “birtttrt”, Input Processing may provide suggestions as if the second “r” was another “t” and treat it as a wildcard character, allowing for a possibility of it being a typographical error caused by a user hitting an adjacent key by mistake since “r” is next to “t” on a typical qwerty keyboard.

One having skill in the art will recognize that other forms of input devices may also be supported. For example, on a watch-type or other wearable device, drawing a letter on a face, a screen, or other input surface digitizer, may provide a character to Input Processing.

If Desired N-Gram is Suggested 240, the user may Select Desired N-Gram 250. If it is not the case Desired N-Gram is Suggested 240, the user may either continue providing input to Receive Inputs 210, for example by pressing backspace or deletion keys or otherwise edit the data entered. The user may also manually type in the desired n-gram at User Manually Enters Desired N-Gram 235, for example.

While the above examples have used words as the desired output, n-grams beside words may also be used. For example, Input Processing could be configured to return physical constants such as pi to a desired number of decimal places by, for example, having “3.144444444” entered to return pi to 9 places after the decimal place. In another embodiment, desired values may be selected from a list by typing an appropriate pattern and displaying a list of matching input. In yet another embodiment, a list may be displayed with descriptions rather than matching patterns, allowing a user to type a short pattern such as a SKU pattern and seeing descriptions of possible matches. When a match is selected, the SKU may be returned to be entered. One having skill in the art will recognize that pattern matching during typing may be applied in many different ways.

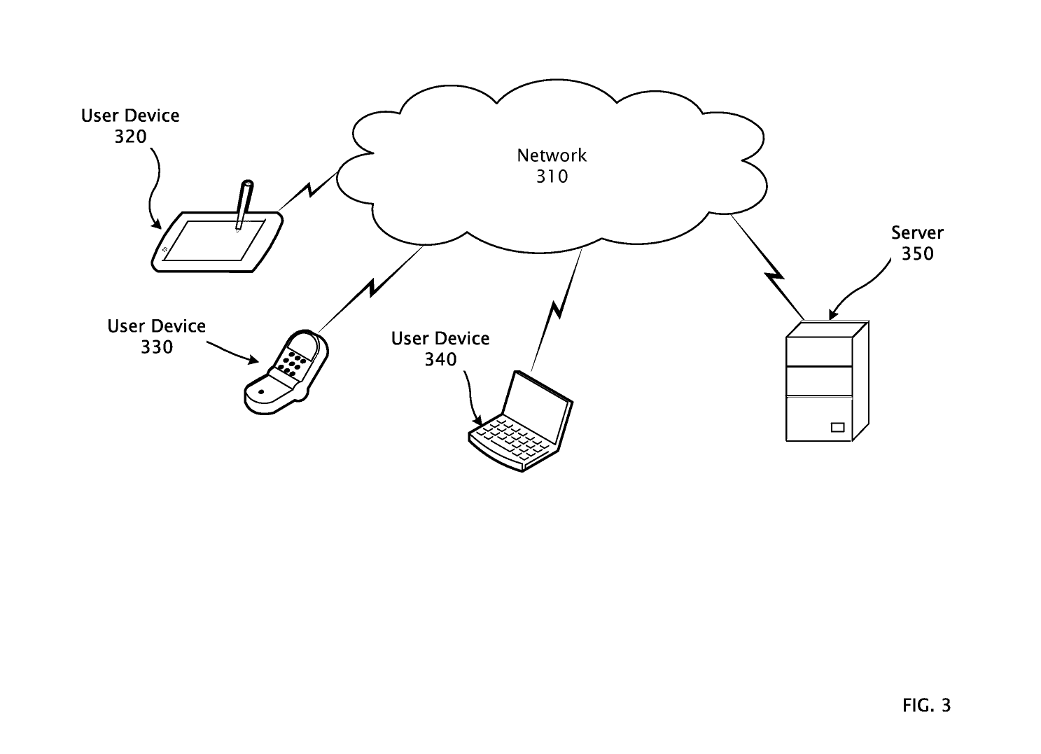

FIG. 3 illustrates a system capable of supporting Input Processing, according to one embodiment. One or more User Device 320, 330, 340 may be coupled to each other, a server, or to other devices via Network 310. User Device 320, 330, 340 may include a desktop computer, laptop computer, smartphone, tablet, or wearable devices such as a smartwatch, activity tracker, or intelligent eyewear, for example.

Network 310 may include Wi-Fi, cellular data access methods, such as 3G or 4GLTE, Bluetooth, NFC, the internet, local area networks, wide area networks, or any combination of these or other means of providing data transfer capabilities. In one embodiment, Network 310 may comprise Ethernet connectivity. In another embodiment, Network 310 may comprise fiber optic connections.

Server 350 may include one or more computers, and may serve several roles. Server 350 may be conventionally constructed, or may be of a special purpose design for Input Processing. One skilled in the art will recognize that Server 350 may be of many different designs and may have different capabilities. Server 350 may host applications, data, or other information supporting Input Processing.

User Device 320, 330, or 340 may be used to access information or programs on Server 350. Such information or programs may include, for example, a dictionary or database which may return suggested words based upon keys pressed for Input Processing. In another embodiment, Server 350 may not be needed, and processing and data storage may be provided locally by User Device 320, 330, or 340.

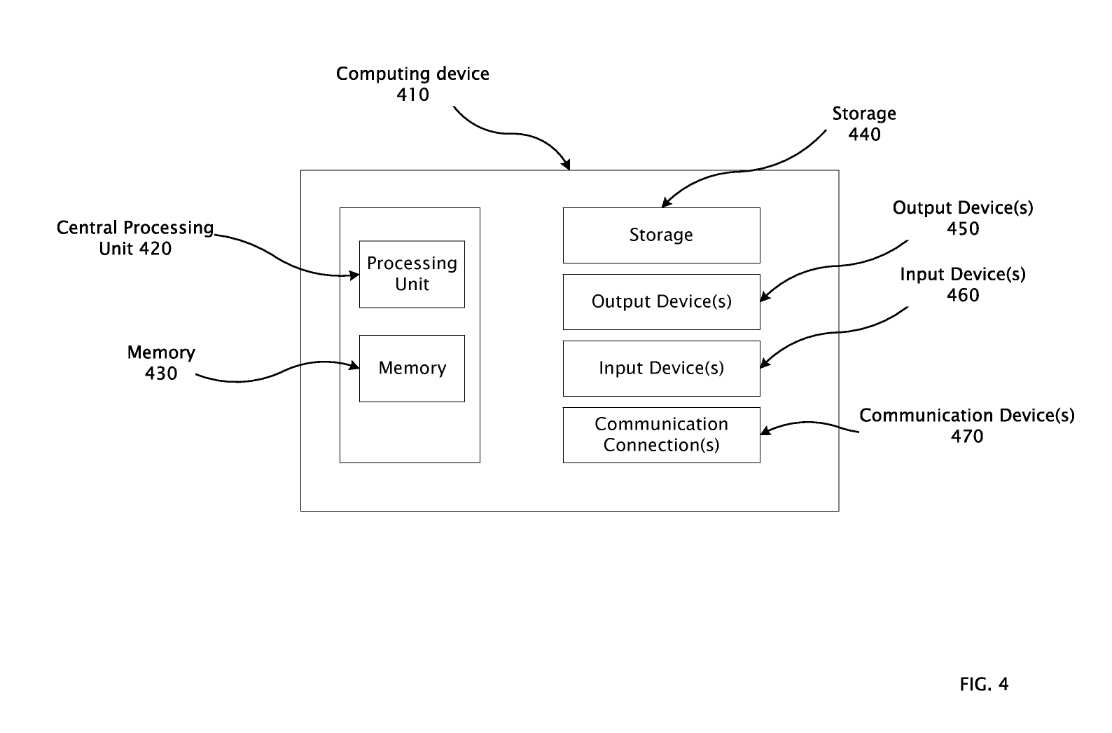

FIG. 4 illustrates a component diagram of Computing Device which may support Input Processing, according to one embodiment. Computing Device 410 can be utilized to implement one or more computing devices, computer processes, or software modules described herein, including, for example, but not limited to a mobile device or a server. In one example, Computing Device 410 can be used to process calculations, execute instructions, and receive and transmit digital signals. In another example, Computing Device 410 can be utilized to process calculations, execute instructions, receive and transmit digital signals, receive and transmit search queries and hypertext, and compile computer code suitable for a mobile device. Computing Device 410 can be any general or special purpose computer now known or to become known capable of performing the steps and/or performing the functions described herein, either in software, hardware, firmware, or a combination thereof.

In its most basic configuration, Computing Device 410 typically includes at least one Central Processing Unit (CPU) 420 and Memory 430. Depending on the exact configuration and type of Computing Device 410, Memory 430 may be volatile (such as RAM), non-volatile (such as ROM, flash memory, etc.) or some combination of the two. Computing Device 410 may also have additional features/functionality. For example, Computing Device 410 may include multiple CPUs. The described methods may be executed in any manner by any processing unit in Computing Device 410. For example, the described process may be executed by both multiple CPUs in parallel.

Computing Device 410 may also include additional storage (removable and/or non-removable) including, but not limited to, magnetic or optical disks or tape. Such additional storage is illustrated in FIG. 4 by Storage 440. Computer readable storage media include volatile and nonvolatile, removable and non-removable media implemented in any method or technology for storage of information such as computer-readable instructions, data structures, program modules or other data. Memory 430 and Storage 440 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by Computing Device 410. Any such computer-readable storage media may be part of Computing Device 410. Computer readable storage media do not include transient signals.

Computing Device 410 may also contain Communication Device(s) 470 that allows the device to communicate with other devices. Communication Device(s) 470 is an example of communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer-readable storage media and communication media. The described methods may be encoded in any computer-readable media in any form, such as data, computer-executable instructions, and the like.

Computing Device 410 may also have Input Device(s) 460 such as keyboard, mouse, pen, voice input device, touch input device, etc. Output Device(s) 450 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above-described logic and still conform to the described embodiments. Further, operations described herein may occur sequentially, or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many embodiments of the invention can be made without departing from the spirit and scope of the invention, the invention resides in the claims hereinafter appended.

1. A method for entering input, comprising:
receiving a series of inputs, the inputs representing a pattern, at least one input repeated contiguously in the series; and
providing one or more n-grams matching the pattern corresponding to the inputs received, treating repeating inputs as wildcards for the purpose of the matching.

2. The method of claim 1, wherein the inputs are received from a keyboard.

3. The method of claim 2, wherein the keyboard is further configured to operate with a device from the list containing desktop computer, laptop computer, smartphone, tablet, smartwatch, activity tracker, intelligent eyewear, and wearable device.

4. The word suggestion menu of claim 1, wherein the word suggestion menu is configured to suggest a word based on the number of times a key is pressed.

5. A method, comprising the steps of:
typing a plurality of keys on a keyboard;
suggesting one or more words based on a number of keys typed;
displaying one or more of the suggested words on a suggestion menu; and
allowing a suggested word to be selected from the suggestion menu.

6. Computer readable storage media containing instructions thereon which, when executed by a processor, perform a method comprising:
receiving a series of inputs, the inputs representing a pattern, at least one input repeated contiguously in the series; and
providing one or more n-grams matching the pattern corresponding to the inputs received, treating repeating inputs as wildcards for the purpose of the matching.
